(19) United States
(12) Patent Application Publication
(10) Pub. No.: US 2008/0306820 A1
(43) Pub. Date: Dec. 11, 2008

(54) PROCESS AND SYSTEM FOR TARGETING OF CONTENT TO SEGMENTED CUSTOMER BASE

(75) Inventor: Eric Passmore, Ashburn, VA (US)

Correspondence Address: DERGOSITS & NOAH LLP, FOUR EMBARCADERO CENTER, SUITE 1450, SAN FRANCISCO, CA, 94111, US

(73) Assignee: Calder Group, Inc., Ashburn, VA (US)

(21) Appl. No.: 11/952,057

(22) Filed: Dec. 6, 2007

Related U.S. Application Data
(60) Provisional application No. 60/873,407, filed on Dec. 6, 2006.

(51) Int. Cl. G06Q 30/00

(52) U.S. Cl. 705/14

(57) ABSTRACT

A method and system for targeted in-store advertising content is disclosed. In order to improve the success of advertising content on a group of customers, the present invention monitors and records items as they are purchased from the store. These records generate data that is used to categorize customers into defined segments. Segments are matched to pre-defined profiles, which describe certain demographic characteristics common to customers in a particular segment. Advertisers can create advertising campaigns directed to these profiles, and when a certain number of matching segments appear within a certain amount of time within the store, the present invention will display the matching media content. The present invention tracks segment frequency, and applies a weighted T-distribution analysis to determine the likelihood of certain frequencies of segments appearing at a certain time. The present invention also tracks the number of times certain media content has been displayed within a certain amount of time to prevent content overexposure. Use of the present invention's data will help advertisers by introducing a pay for performance model where advertisers pay to deliver content to their target demographic, and by providing information on whether or not an advertising campaign was successful.

### RELATED APPLICATION DATA

This nonprovisional utility patent application claims priority under 35 U.S.C. § 119(e)(1) to provisional patent application No. 60/873,407, filed on Dec. 6, 2006.

### TECHNICAL FIELD

The present invention relates generally to targeted advertising. Specifically, the present invention is directed toward a process and system for monitoring customer purchases, tracking groups of customers fitting a common profile, and using statistical analysis to target advertising content to other customers based on the tracking results.

### BACKGROUND OF THE INVENTION

Advertising is an industry that relies upon accurate consumer behavior data in order to best direct appropriate content to the most viable audience. Indeed, the most revenue is generated when an advertiser is presented with an aggregated market of common consumers. A receptive audience increases the propensity for purchases based upon relevant advertising; consequently, successful advertisers whose content generates the most sales for their clients command higher fees.

Technological advances have been applied to the field of advertising; however, most applications have been directed to lengthy post-sale analyses of consumer trends. Advertisers must wait until long after a purchase is made before they can see whether or not an advertising campaign is successful. Any statistical analysis of the sales data takes place long after the data is collected and compiled. The statistical analysis that is performed tends to be descriptive in nature, responding only to purchases made in the distant past to direct the advertising campaign of the future. Additionally, most technological advances have been directed toward Internet advertising, using software programs to record web site addresses visited by users. The environment where customers are most likely to be in a purchasing mood is in a physical store or shop, yet this environment has been largely ignored. At present, there are no real-time in-store methods of tracking consumer spending and adjusting advertising quickly.

An ideal advertising system would be able to generate sales by targeting content appropriately and quickly, resulting in revenue and building brand loyalty for the advertising client. What is needed is a system that enables advertisers to track customer purchasing decisions as they happen. Real-time data monitoring and analysis will allow the advertiser to automatically display tailored advertising to common customers while those customers are likely to be in the shopping environment. What is needed is a system that can quickly and efficiently identify that customer's demographic to ensure that the advertising is properly directed and relevant. What is needed is a system that can use prior customer responses to directed advertising to predict similar customers' reactions to future advertising content. The desired system needs to balance content delivery without inundating the audience with repetitive advertising. The system should also be able to deliver generic content in the event the customer cannot be categorized or in the event that the content has already been shown. The system should present data that is easily understood, so that high-performing advertising campaigns can be readily identified, while low-performing advertising campaigns can be re-tooled or removed. The system should also enable advertisers to set billing rates based upon the analyzed data, making it easier for clients to judge whether or not there is sufficient return on investment to justify the advertising and marketing costs of a campaign. Likewise, the system should enable advertising clients to monitor the costs of a campaign to determine if it is money well spent.

### SUMMARY OF THE INVENTION

The present invention is a real-time monitoring process and system that delivers relevant and appropriate advertising content to customers based upon accurate categorization of those customers into identifiable segments. The present invention gathers information about a customer using purchased items in the customer's shopping basket, analyzes the items in the shopping basket to create a data set, uses the data set to categorize the customer into a certain segment or segments, matches the segment to a pre-defined profile, then delivers specific advertising content for that profile to a display near the customer. The present invention tracks the frequency and presence of certain profiles, and predicts the propensity of similar customer groups in the store, then displays appropriate content accordingly. Rather than apply complicated statistical or mathematical models to the customer data, the present invention uses a simple weighted T-distribution curve to accurately predict customer buying habits. The present invention does not collect personal or private information about any customer, but rather relies on the items placed in the shopping basket to deliver relevant advertising content. The present invention also tracks the amount of content delivered to avoid overuse of certain content within a timeframe. In the event that certain advertising content has already been delivered within a certain time interval, or in the event the customer escapes categorization, the present invention will deliver generic or alternative advertising content while monitoring customer response.

In order to practice the present invention, the system requires a software module that monitors the information gathered from many shopping baskets at the time of checkout. This may be done by a computer system which analyzes the information with the purpose of cleaning the data, filtering the data to categorize customers into certain segments, matching those segments to pre-defined profiles, and calculating the likely presence of a particular customer segment present in the store. The computer system also implements profile analysis by taking in groups of segments and applying a weighted T-distribution algorithm. This enables the present invention to determine the percent chance that a specific segment is present in the store at a specific point in time, and the percent chance that a particular content has been shown N times to that same segment. The present invention also analyzes the effect that the displayed content has on sales of the content's featured products. As such, content can be ranked by performance and used to set advertising fees or assess the reasonableness of those fees. The present invention also enables ranking of the content to determine performance and set fees for displaying such content. Finally, in order to deliver the content, the present invention requires a display system connected to the content delivery computer system, and comprising of a monitor, projector, LCD, or other display system capable of displaying both still images and video content, and a speakers capable of playing sounds and music.

### BRIEF DESCRIPTION OF THE FIGURES

The present invention is illustrated by way of example and not limitation in the Figures of the accompanying drawings, in which like references indicate similar elements, and in which:

FIG. 1 depicts a logical operation flow for the present invention, according to one embodiment of the present invention.

FIG. 2 is a block diagram depicting some of the elements of the present invention, according to one embodiment.

FIG. 3 is a block diagram depicting some additional elements of the present invention, according to one embodiment.

FIG. 4 is a block diagram illustrating the relationship between customer segments and confidence ratings, according to one embodiment of the present invention.

### DETAILED DESCRIPTION OF THE INVENTION

A directed advertising data gathering and analysis process and system are disclosed. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of the preferred embodiments is not intended to limit the scope of the claims appended hereto.

Aspects of the present invention may be implemented on one or more computers executing software instructions. According to one embodiment of the present invention, server and client computer systems transmit and receive data over a computer network and/or a wireless, fiber, or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network,” “computer network,” and “online” may be used interchangeably and do not imply a particular network embodiment or topography. In general, any type of network (e.g., LAN, WAN, or Internet) may be used to implement the online or computer networked implementation of the present invention. Similarly, any type of protocol (e.g., HTTP, FTP, ICMP, UDP, WAP) may be used to communicate across the network.

What is disclosed is a novel process and system to use readily available information on shopping customers to customize and target relevant advertising content. The present invention includes a system with generalized components to gather data on a customer, analyze the data, categorize the customer based on the analyzed data, match the categorized customer to a prescribed profile, then deliver content relevant to that profile. As such, a UPC bar code scanner, computer and data storage device, or other low-cost commodity hardware components may implement the present invention. Additionally, radio frequency identification (RFID) tags, embedded microchips or other embedded tracking hardware can be used to gather data on the customer. The system may be augmented with additional components to provide information to the advertiser or retailer, such as content ranking, promotion notification, feedback mechanisms and/or a remote storage facility to safely secure information. While there are a number of currently available hardware and software components that can practice the present invention, a preferred embodiment is disclosed herein, but is in no way meant to be limiting.

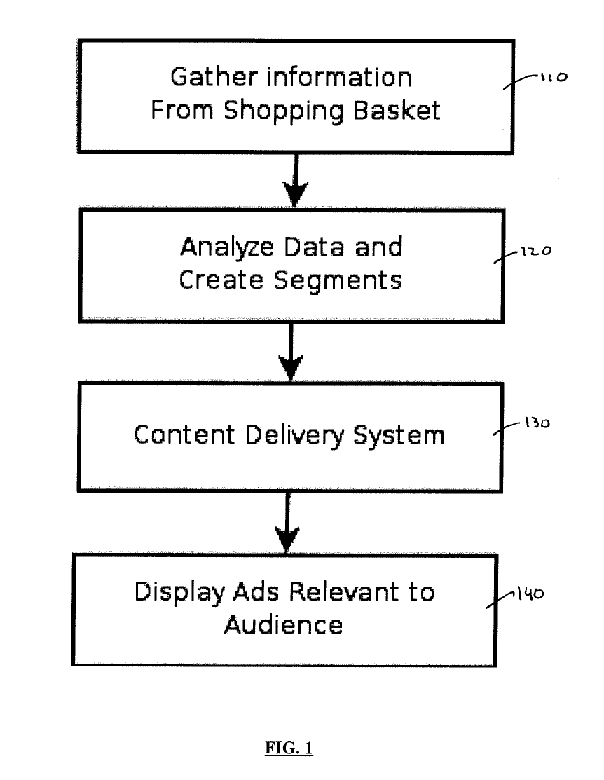

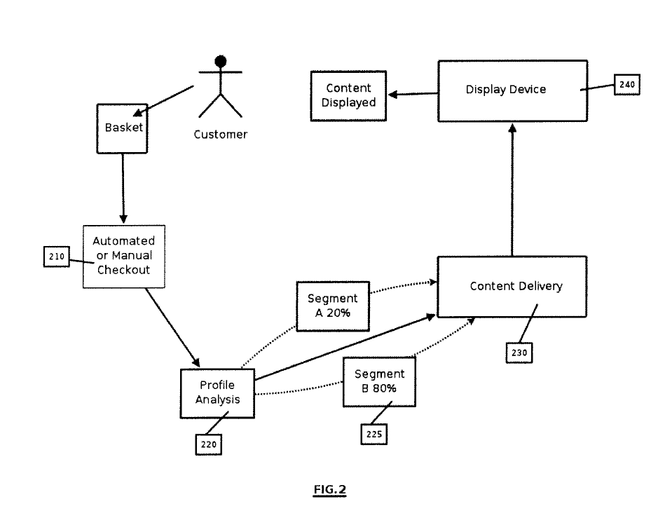

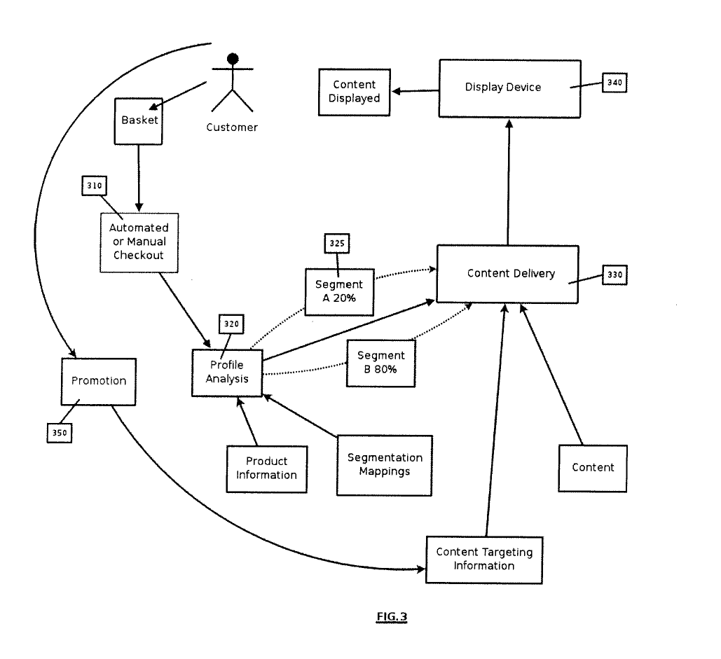

According to one embodiment of the present invention, the system identifies and records purchased items when the customer is at the point-of-sale, checkout or cashier station. This is shown as step 110 in FIG. 1, 210 in FIG. 2 and 310 in FIG. 3. Other data points surrounding the purchase, such as item quantity and time/date information, may also be recorded. The information is saved into a database associated with a computer system accessible by the store.

According to one embodiment of the present invention, information gathered from the shopping basket purchases is compiled and filtered to categorize customers into pre-defined segments. This is illustrated as step 120 in FIG. 1. A customer can belong to one or more segments depending on what products were purchased. 225 of FIG. 2 illustrates that a customer profile may match or be placed in 80% of Segment A and 20% of Segment B. For example, in one embodiment a customer who buys dog food is filtered into the “dog owner” segment, whereas a customer who buys cat food would be filtered into the “cat owner” segment. To map a customer to a particular segment, the database or the computer routing the data to the database executes a software program function using the gathered information. In one embodiment of the present invention, the following lines of code operate to distinguish a customer into a dog owner segment or a cat owner segment:

for all products I {

if ( i.category = = “dog food”) {

segment = “dog owner”

}
if ( i.category = = “cat food”)

segment = “cat owner”

}

}
return segment

One skilled in the relevant are will appreciate that the available types of segments are infinite, limited only to the needs and requirements of the store or advertiser implementing the present invention.

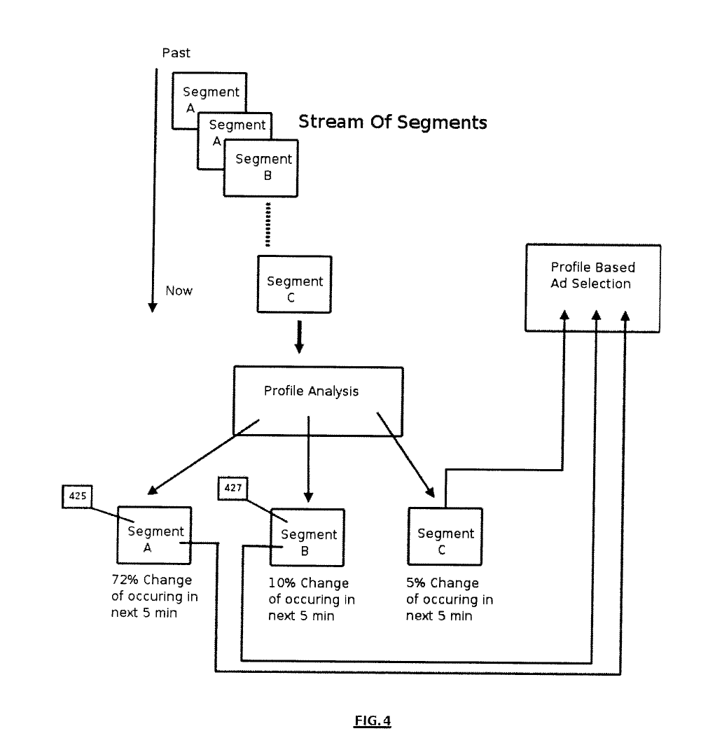

Each pre-defined segment belongs to an associated profile. The profile is a description of the segment and may include the results of offline demographic analysis or other marketing theories. For the dog owner segment, the profile might provide the following:
DOG LOVER: dog owner segment, male between the ages of 25 and 38, loves to acquire new toys and gadgets, likely to have an annual income of $90K. Favorite brands include BMW, Budweiser, and ACME.
   Segment information is useful to an advertiser, since it assists in choosing relevant content for the appropriate customer profile. An advertiser who knows that a certain profile is being represented in a store will want to target that profile with certain content; however, the first encounter with the profile comes after the first customer with that profile makes a matching purchase. Advertisers will want to know the next time such a profile is encountered in order to cue up the appropriate content. This concept is illustrated generally in FIG. 4.

According to one embodiment of the present invention, this predictive knowledge is gained by applying weighted T-distribution analysis to the gathered customer data. In a preferred embodiment, the present invention gathers information on customers throughout the business day, logging how many of what items were purchased at what time. This permits segments to be categorized in time groups to monitor for the presence of certain profiles during certain times of day. For example, 425 and 427 of FIG. 4 show groupings of customers based upon these segments. By recording the time between similar segments, the present invention can apply statistical analysis to predict when certain profiles are likely to be represented at a certain time, and the present invention can react accordingly. For example, if dog food is purchased every five minutes from 3:00 p.m. to 5:00 p.m. on Saturdays, the present invention will assume that this is the likely time that DOG LOVERS appear in the store. The present invention will continue with this assumption until dog food purchases become less frequent. Each dog food purchase is weighted so that the most recent occurrence is more important then the earliest recorded occurrence. The present invention applies a weighted T-distribution is used to predict the time of the next encounter with a specific profile. As more data is gathered and analyzed, the predictive accuracy of the present invention will improve. In a preferred embodiment, the present invention produces confidence ratings of its predictive accuracy numerically or as a percentage. One will appreciate that a weighted T-distribution has several variables that may be adjusted, and that a weighted T-distribution is simply one statistical analysis technique that can apply to the present invention.

Once the present invention calculates, to an acceptable degree of confidence, the predictive behavior of future customers based upon recent customer purchases, pre-recorded content may be targeted to those relevant segments. The content delivery element of the present invention is tasked with delivering a certain number of content pieces to a specific set of segments. This is shown as 130 in FIG. 1, 230 in FIG. 2 and 330 in FIG. 3. In a preferred embodiment, the present invention has a number of different types of advertising media content stored in a memory device so that it can call up relevant content for display whenever appropriate. A store using the present invention would place, in one or more locations around the store, apparatuses capable of displaying content, such as LCD screens, television screens or similar devices (step 140 of FIG. 1, 240 of FIG. 2 and 340 of FIG. 3). The content displayed can include movie teasers, advertisements, or tales of excitement involving the products and services marketed by the retailer.

The present invention is not simply a video-on-demand system that automatically reacts to the presence of certain profiles. In a preferred embodiment, the present invention also avoids overexposing customers to advertising content. Overexposure reduces the impact of an advertising message and often works to the detriment of the product being advertised. To avoid this, the present invention monitors the number of times certain content is displayed within a time interval. Content that has reached the frequency limit will not be shown.

Applying the previous example, a completed purchase of dog food indicates that the customer belongs in the dog owner segment. If dog food was purchased every five minutes over the last hour, the present invention would have a very high confidence rating that someone in the dog owner segment, and therefore the DOG LOVER profile, will make a purchase in the next five minutes. Because the DOG LOVER profile defines this segment of customers as being of a certain socio-economic status and having a certain preference for specific luxury brands, the present invention would serve advertising content for ACME jet packs and BMW automobiles. That particular content has been mapped to DOG LOVER customers. At the same time, the present invention would limit delivery of this specific content within a certain time interval, reducing the likelihood that the same DOG LOVER customer will keep seeing the same advertisement.

In another embodiment, the present invention may be presented with a situation when it cannot recommend a specific piece of content to deliver, either because frequency limits were reached, or there is no identifiable customer profile. In such a case, the present invention is intelligent and flexible enough to deliver public service messages, cheaper advertising content or generic advertising content.

The ability of the present invention to gather customer data, identify customer profiles and apply statistical analysis to the data is useful for a number of reasons. In a preferred embodiment, the present invention uses the statistics to calculate a percent likelihood that certain customer profiles appear at certain times. Not only does this permit intelligent advertising delivery, but this also enables advertisers to test marketing theories and gather quick results. The present invention's calculations occur in real time, and all aspects of the present invention, except segmentation, may occur at any time. The real time ability to adjust or fine-tune the segments, profiles and content delivery of the present invention is yet another desired advantage for advertisers or marketing professionals who would like to experiment with their promotions.

Another benefit of real-time targeted content delivery invention is that it enables advertisers to extend their marketing reach in a targeted way. With each showing of a relevant advertisement, customers are being exposed to an advertisement having specific appeal to them. Additionally, the advertiser has control over how often the targeted advertisement is shown, and to whom, based upon the present inventions confidence ratings methodology. Such numbers are easily understood by advertisers, retailers and marketing teams.

In addition to the embodiment described previously, added features may be implemented in conjunction with the present invention in order to provide added benefit to its users. These features can appear after content delivery. When certain content is displayed, the present invention can also deliver simultaneous promotions. A store implementing the present invention can work with the advertiser, product placement company or can independently produce additional offers or coupons or other promotion notifications that partner with the displayed content. In this embodiment, the present invention puts a feedback loop in place to increasing product exposure and also generating a method to track content performance.

According to this embodiment, the present invention readies the stored content directed to a specific profile. For example, in one embodiment, an advertisement showing dog supplies or dog food would be relevant to dog owners. According to the defined profile, dog owners tend be wealthy DOG LOVERS with an affinity to ACME products. In order to practice the feedback element of the present invention, there must be a promotion or promotion code associated with ACME if ACME content is going to be shown and assessed. Specifically, the promotion code would need to tie back to a specific piece of content and a set of one or more purchased items in a shopping basket. Tying a promotion code to content may be accomplished by using the present invention's content delivery system to insert a promotion code. The promotion code could be present in the content itself, or placed on the printed receipt from the store. (350 of FIG. 3). A combined presentation of the promotion code in both the content and the receipt is also possible. In one embodiment, the sales receipt includes a unique identifier and promotion code issued by the register or other point of sale device. In another embodiment, the delivered content displays a series of letters or numbers that customers can personally record and use later.

After release of the promotion code, the present invention records the issuance of the promotion, and monitors for subsequent redemption or use of that promotion, according to one embodiment of the present invention. This is done in addition to the monitoring, segmentation, profiling and content delivery initiated by each customer purchase. Because the present invention can tangibly produce and track promotions tied to specific products, the present invention has the added benefit of being able to determine the success of an advertising campaign. In one embodiment, further analysis reveals how successful the promotion was for particular customer segments. In another embodiment, the present invention enables users to see whether particular promotions are effective, and if not, users can adjust the campaign accordingly.

The success of an advertising campaign can be tied to the confidence rating system provided by the present invention. Those campaigns that correlate to a high confidence rating and a high return on promotional investment can then be used to set the rates for the content providers. Conversely, companies working with advertisers that use the present invention's technology will get data on whether or not the advertisers are worth their rate. Thus, not only does the present invention provide a more efficient and better targeted system for delivering content to specific customer groups, it also provides data on the success of the delivered content, and the reasonableness of the cost of producing and delivering the content. One skilled in the art will appreciate that the market research generated by the present invention has a number of potential uses in the marketplace.

In the preferred embodiment, data is gathered when the customer purchases the item; however, one skilled in the art will appreciate that adding components to the present invention can uncover other data relevant to the present invention. For example, in an alternate embodiment, store items can be tagged with RFID tags or other embedded microchip technology, such that the present invention can track movement of the items and customers in the store. Additionally, the present invention can collect data on whether items chosen by the customer are ultimately purchased. Such information is not only valuable to the store and the item manufacturer for marketing purposes, but can also be used to categorize customers into alternate segments for targeted advertising content delivery. Similarly, this information can be used in conjunction with promotions or other feedback mechanisms to determine the effectiveness of the advertising campaign.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than restrictive sense.

Additionally, although embodiments of the present invention have been described with reference to a network implementation comprising the internet and internet-related web browsing and web serving technologies, it should be noted that alternative embodiments of the present invention can be implemented on many other types of networks and network protocols, such as proprietary protocols for local area networks, wide area networks, and any combination thereof.

What is claimed is:

1. A method comprising:
identifying an item purchased by a first customer;
categorizing the first customer into a first segment, the first segment based upon the item purchased by the customer;
matching the first segment with a pre-determined profile; and
displaying previously-stored advertising content associated with the pre-determined profile.

2. The method of claim 1, further comprising adding additional product information before categorizing the customer into a segment; and using the additional product information to categorize the customer into a segment.

3. The method of claim 1, further comprising:
recording first temporal data during the identification step for the item purchased by the first customer;
recording second temporal data point the identification step for an item purchased by a second customer, the second customer categorized in the same segment as the first customer; and
applying a probability distribution to the first and second temporal data point to determine a confidence rating, the confidence rating representing the likelihood that a third customer will purchase an item, resulting in the third customer being categorized in a third segment that is the same as the first customer's segment.

4. The method of claim 1, further comprising:
defining a time interval;
defining a content frequency limit;
counting how many times the previously-stored advertising content is displayed within the defined time interval;
ceasing display of the previously-stored advertising content once the counting step reaches a limit the content frequency limit within the time interval; and
displaying previously-stored advertising content not associated with the pre-determined profile.

5. The method of claim 1, further comprising:
providing an item promotional code to the customer after purchase; and
monitoring for use of the promotional code.

6. The method of claim 4, further comprising recording data, the data including information on the date and time the item promotional code was provided, and the date and time the item promotional code was used.

7. A system comprising:
a shopping basket monitor software module that collects data on at least one item purchased by at least one customer, the shopping basket monitor software module stored in a memory device;
a profile analysis software module that uses the collected data from the shopping basket monitor module and categorizes the customer into a segment based upon the data, and then matches the segment to a pre-defined profile, the profile analysis software module stored in a memory device;
a content database that contains at least one previously-stored advertising content file matching at least one profile, the advertiser database stored in a memory device;
a content delivery software module that transmits, to a display device, advertising content matched to at least one profile, the content delivery software module stored in a memory device; and
a display device that displays advertising content transmitted from the content delivery software module.

8. The system of claim 7, wherein the content delivery software module uses a confidence rating to match previously stored content to at least one segment.

9. The system of claim 7, wherein the content delivery software module charges different fees for advertising content transmitted with different confidence rating

10. The system of claim 7, wherein the content delivery software module records the number of times a media content is transmitted to the display device.

11. The system of claim 7, wherein the content delivery software module transmits, to a display device, advertising content that is not matched to at least one profile.

12. The display device of claim 7, the display device capable of displaying digital and analog media.

13. The system of claim 7, further comprising a feedback loop software module that produces a promotion code for at least one media content, and records when that promotion code is used.
